(19) United States
(12) Patent Application Publication
(10) Pub. No.: US 2022/0183427 A1
(43) Pub. Date: Jun. 16, 2022

(54) INTEGRATED LOCKING MECHANISM FOR WATCH OR SIMILAR STYLE STRAP

(71) Applicant: FIND-8 SYSTEMS LTD, London (GB)

(72) Inventors: Dean J E Souyana, Sunbury on Thames (GB); David M J Finch, Addlestone (GB)

(21) Appl. No.: 17/440,121

(22) PCT Filed: Mar. 19, 2020
(86) PCT No.: PCT/GB2020/050727

§ 371 Date: Sep. 16, 2021

(30) Foreign Application Priority Data
Mar. 19, 2019 (GB) 1903740.7
Feb. 17, 2020 (GB) 2002128.3

(51) Int. Cl. A44C 5/20; E05B 73/00; E05B 27/00

(52) U.S. Cl. CPC A44C 5/2076; E05B 27/00; E05B 73/0017

(57) ABSTRACT

There is provided a locking device for locking a wrist/leg worn device, the locking device comprising: a receiver unit having a frame structure that defines a cavity, wherein the frame structure comprises a locking edge; and a lock unit comprising a lock bar, wherein the frame structure defines an opening to the cavity configured to receive the lock bar through a sliding movement of the lock bar into the cavity such that once the lock bar is received within the cavity the lock bar engages the locking edge so as to lock the receiver unit and the lock unit together.

### PRIORITY CLAIM

The instant application claims priority as a U.S. Nationalization to International Application PCT/GB2020/050727 filed on Mar. 19, 2020, presently pending, which in turn claimed priority to UK application 1903740.7 filed on Mar. 19, 2019, and UK application 2002128.3, filed on Feb. 17, 2020. The contents of each application are hereby incorporated by reference.

### BACKGROUND

This invention relates to the security of a watch or similar style device which is utilising GPS or other types of tracking systems such as Wi-Fi or cellular location systems designed to be worn on the wrist or other suitable place on the body.

When a Child or Person with limited capacity is given a GPS style watch or other wearable based device capable of using GPS or other means to locate there position and or location, or to notify someone of an emergency or abduction the watch or other wrist style unit can be removed by undoing the strap and disposing of the GPS watch or similar wrist warn device.

This defeats the purpose of the tracking unit in ensuring the wearer is safe.

The use of conventional watch or wrist style straps are insufficient to maintain the security features of the device to be of proper and effective use.

The Integrated Locking Mechanism locks the watch, GPS unit or other style tracking unit to the wearer's wrist or other appropriate part of the body.

This ensures that the watch, GPS unit or other type of tracking unit cannot be removed without the lock key or similar style unit.

This maintains the integrity, the proper security and effective use of the watch, GPS unit or other wearable type of tracking system in an emergency or abduction scenario.

The Integrated Locking Mechanism by way of it's incorporated cable ensures that the watch, GPS unit or other type of wearable tracking unit cannot be cut off by shears or another style or type of cutting device or mechanism thus ensuring the proper security and effective use of the watch, GPS unit or other type of wearable tracking system is maintained in an emergency or abduction scenario.

The Integrated locking mechanism and cable is designed to be embedded into a Rubber or Silicone/Rubber compound or other flexible material style wrist or other type of wearable strap.

### SUMMARY

In an aspect of the present invention, there is provided a locking device for locking a wrist/leg worn device, the locking device comprising: a receiver unit having a frame structure that defines a cavity, wherein the frame structure comprises a locking edge; and a lock unit comprising a lock bar, wherein the frame structure defines an opening to the cavity configured to receive the lock bar through a sliding movement of the lock bar into the cavity such that once the lock bar is received within the cavity the lock bar engages the locking edge so as to lock the receiver unit and the lock unit together.

In certain embodiments, the locking edge is generally parallel to the horizontal length of the receiver unit.

In certain embodiments, the opening of the frame structure comprises a bevelled section configured to abut against the lock bar during insertion of the lock bar into the cavity such that the lock bar is urged into the cavity.

In certain embodiments, the bevelled section is generally parallel to the horizontal length of the receiver unit.

In certain embodiments, the lock bar is biased so as to maintain engagement with the locking edge once the lock bar is received within the cavity, and, optionally, the lock bar is biased using one or more springs so as to maintain engagement with the locking edge.

In certain embodiments, the lock unit is configured to be unlocked from the receiver unit by unengaging the lock bar and the locking edge.

In certain embodiments, the lock unit is configured to be unlocked from the receiver unit by using a key.

In certain embodiments, the lock unit comprises a cylinder style lock configured to unlock the lock unit from the receiver unit by unengaging the lock bar and the locking edge, and, optionally, wherein the cylinder style lock is key operable.

In certain embodiments, the lock unit comprises a lock holder configured to removably receive the cylinder style lock therein.

In certain embodiments, the lock bar comprises an extension, preferably an L-shaped extension, and, optionally, wherein the extension is configured to be engaged by a lock of the locking unit, preferably a cylinder style lock, so as to unengaged the lock bar and locking edge upon unlocking of the lock.

In certain embodiments, the receiver unit is generally in the shape of a rectangular cuboid, wherein the lock unit is generally in the shape of a rectangular cuboid, and wherein the opening of the cavity is defined in a side of the rectangular cuboid of the receiver unit.

In certain embodiments, the locking device further comprises at least one strap extending from the receiver unit and/or the lock unit.

In certain embodiments, the locking device comprises a first strap extending from the receiver unit and a second strap extending from the lock unit.

In certain embodiments, the locking device comprises a strap extending from the receiver unit to the lock unit such that the strap connects the receiver unit to the lock unit.

In certain embodiments, each strap comprises at least one or two cables each running generally along the length of the respective strap, preferably, at least one or each of the cables being steel cables.

In certain embodiments, each cable is fixedly attached to the receiver unit and/or the lock unit.

In another aspect of the present invention, there is provided a GPS tracking device comprising the locking device as described anywhere herein, optionally, wherein the GPS tracking device is configured to be worn around the wrist/leg.

In another aspect of the present invention, there is provided a watch comprising the locking device as described anywhere herein, wherein the watch comprises a GPS tracking module.

### BRIEF DESCRIPTION OF THE DRAWINGS

The invention will now be described solely by way of example and with reference to the accompanying drawings in which:

FIG. 1 illustrates the Receiver unit.

FIG. 2 illustrates the front of the receiver unit of FIG. 1.

FIG. 3 illustrates the rear of the receiver unit of FIG. 1.

FIG. 4 illustrates the top view of the receiver unit with the lid removed of FIG. 1.

FIG. 5 illustrates a top and rear view of the receiver unit with the lid removed of FIG. 1.

FIG. 6 illustrates the the rear of the lid unit of FIG. 1.

FIG. 7 illustrates the top of the lid unit of FIG. 1.

FIG. 8 illustrates the Lock unit.

FIG. 9 illustrates a top view of the Lock Unit of FIG. 8.

FIG. 10 illustrates the front view of the Lock Unit of FIG. 8.

FIG. 11 illustrates the rear view of the Lock Unit of FIG. 8.

FIG. 12 illustrates the Left side of the Lock Unit of FIG. 8.

FIG. 13 illustrates the Right side of the Lock Unit of FIG. 8.

FIG. 14 illustrates a top and rear view of the Lock Unit with the lid removed of FIG. 8

FIG. 15 illustrates the Right view of the Lock Bar (17) of FIG. 8.

FIG. 16 illustrates the Left view of the Lock Bar (17) of FIG. 8.

FIG. 17 illustrates the bottom view of the Lock Bar (17) of FIG. 8.

FIG. 18 illustrates the top view of the Lock Bar (17) of FIG. 8.

FIG. 19 illustrates the top, right side and front view of the Lock Unit Lid of FIG. 8.

FIG. 20 illustrates the top, right side and rear view of the Lock Unit Lid of FIG. 8.

FIG. 21 illustrates the Receiver Unit of FIG. 1 and the Lock Unit of FIG. 8 in the Open position.

FIG. 22 illustrates the Receiver Unit of FIG. 1 and Lock Unit of FIG. 8 in the Locked position.

FIG. 23 illustrates the Steel Cable.

FIG. 24 illustrates the entire unit fully assembled.

FIG. 25 illustrates another configuration of the steel cable which comprises a steel plate.

FIG. 26 illustrates a further configuration of the steel cable comprising a twin cable pin attachment system.

FIG. 27 illustrates a further configuration of the steel cable which comprises only/exactly a single cable.

FIG. 28 illustrates another configuration of the lock unit which is curved.

### DETAILED DESCRIPTION

The invention and its embodiments will be explained now by reference to the figures.

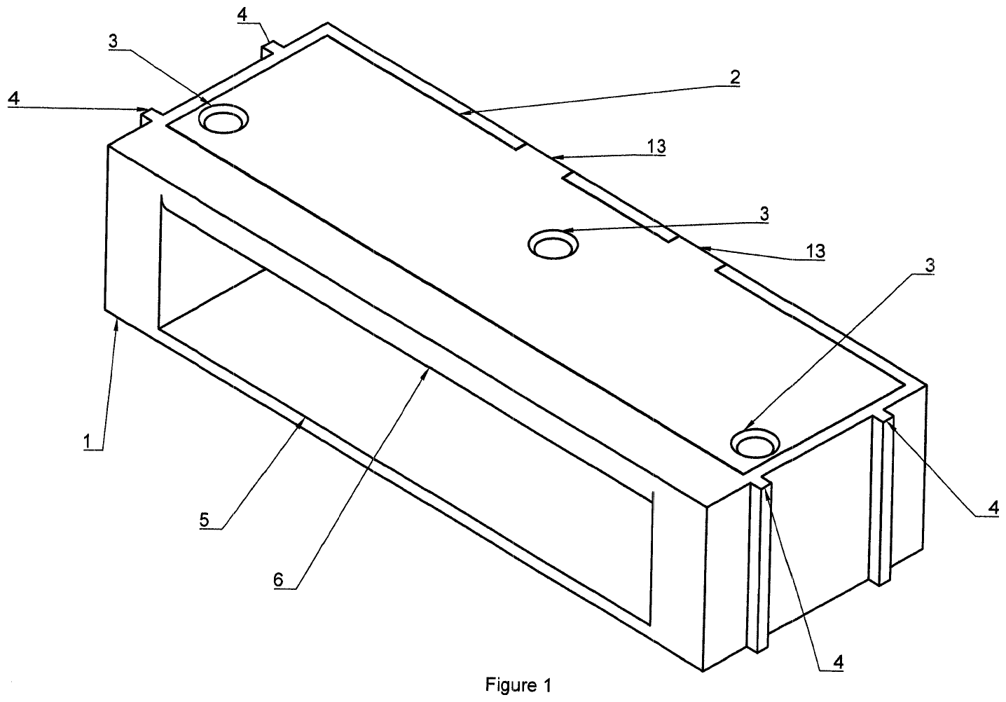

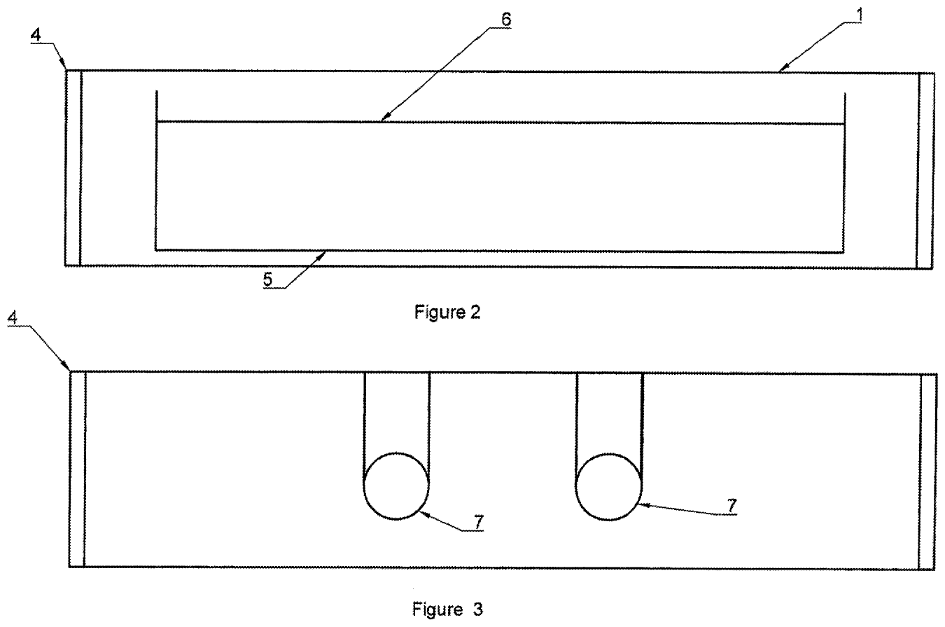

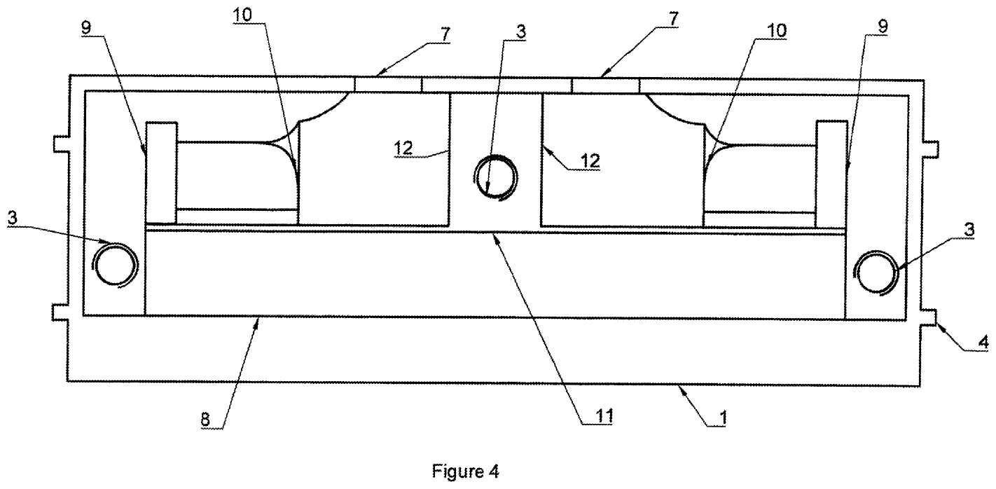

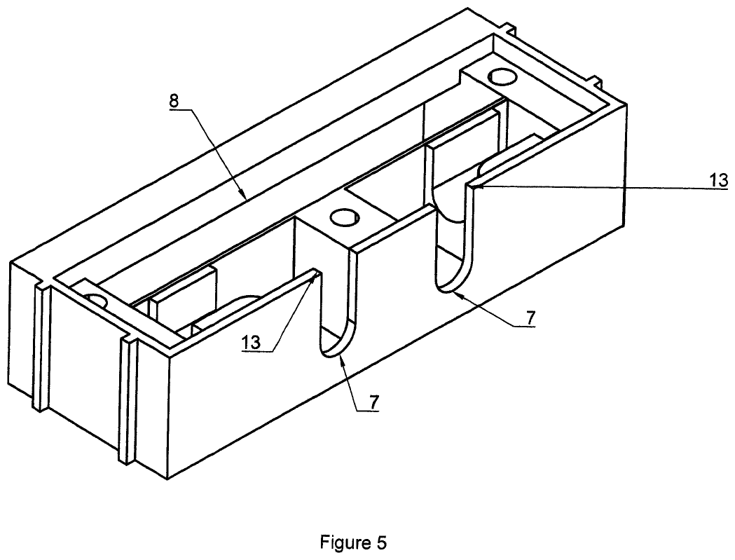

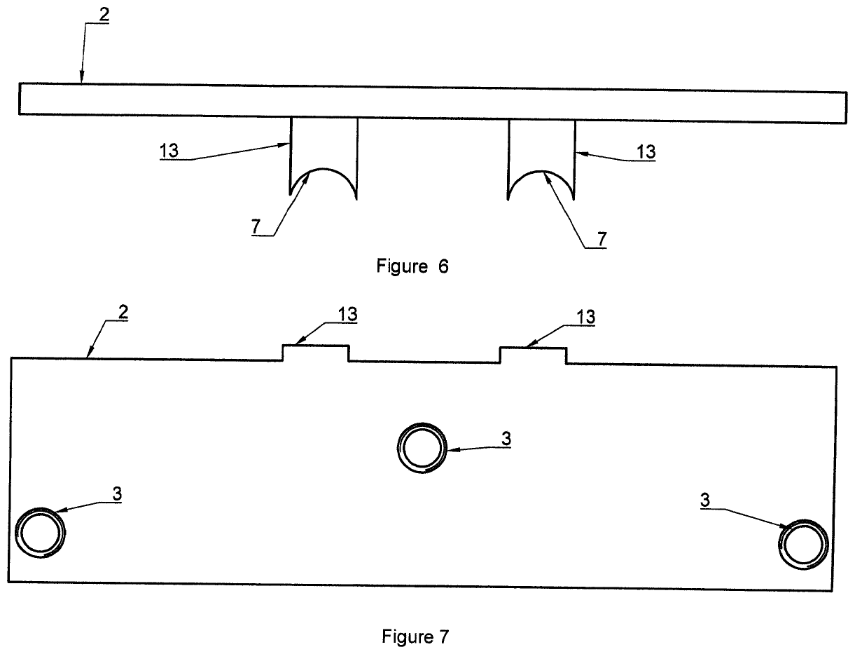

1.) Receiver Unit: FIGS. 1 to 7. The Receiver unit 1 is a single metal box with a lid 2, fixed by three screws 3.

The Receiver unit has two sidebars 4 situated to both the right and left sides extending from the main box section to hold the unit firmly into a watch or similar type strap.

The Receiver unit contains three screw holes 3 to secure the lid 2 to the box 1.

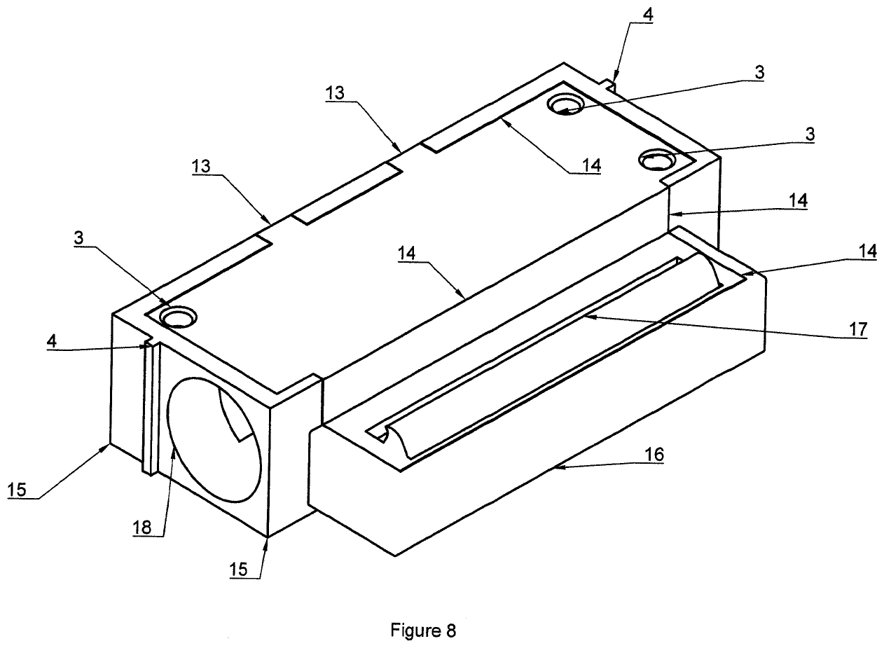

The Receiver unit has a slot cut into the front face 5 to receive the Lock unit drawer FIG. 8 16.

There is a bevelled section 6 along the top edge of the opening slot 5 to assist in pushing the Lock Bar FIG. 8 17 down into its drawer housing FIG. 8 16 as it is inserted into the receiver.

The inside top section at the front of the receiver unit 1 contains a thick locking edge 8 to hold the Lock bar firmly in position once the Lock unit drawer FIG. 8 16 is fully Inserted in to the slot 5.

The cable holders 10 are situated in the rear of the receiver unit 1 and are separated from the front slot by a centre wall 11.

The two independent cable holders 10 are also separated by a central wall 12.

The cable housing 9 secures the Grommet FIG. 23 32 attached to the cable FIG. 23 31 in the cable holders 10.

The cable FIG. 23 31 leaves the Receiver unit by way of a hole 7a situated in the rear face of the unit.

The holes 7a in the rear of the unit have a slot 13a cut above them into box 1 to facilitate assembly.

The Lid 2 of the Receiver unit has two side bars 13b on the rear edge to enclose the holes 7a for the cable 31.

The Lid 2 of the Receiver 1 contains three counter sunk screw holes 3 to secure the lid to the receiver unit with non removable type screws.

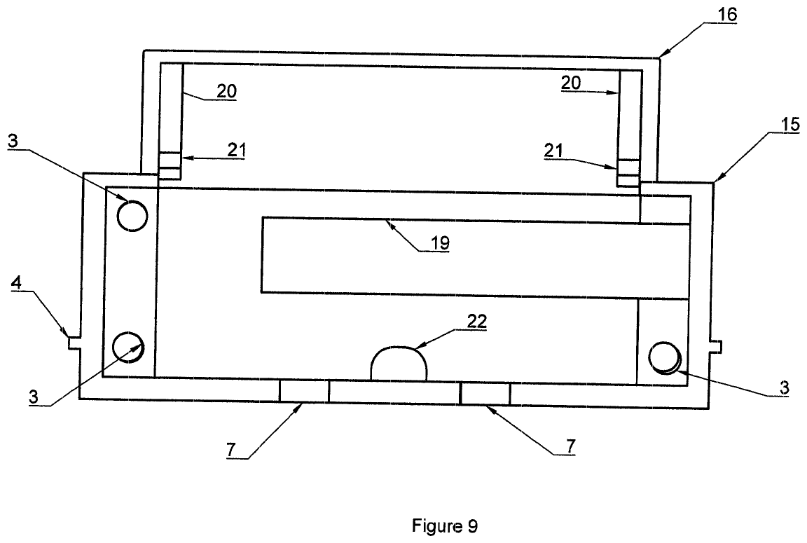

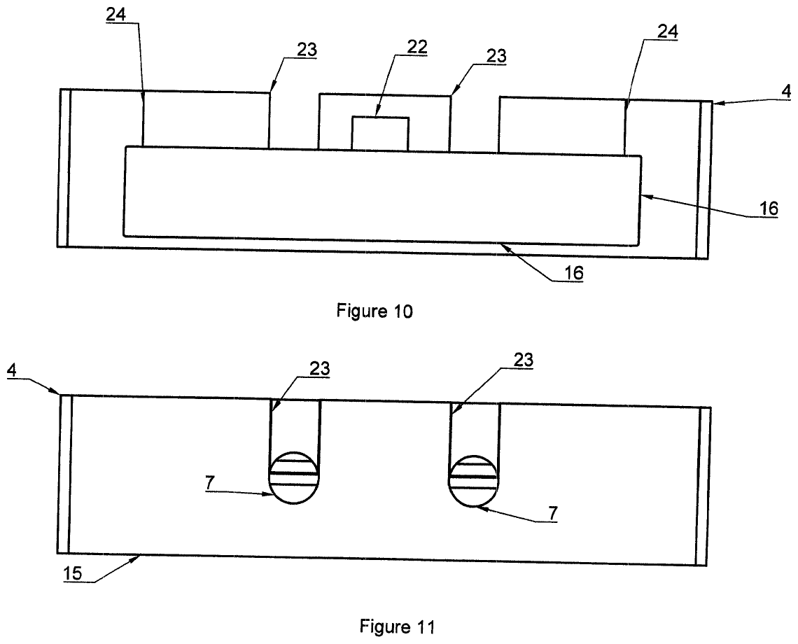

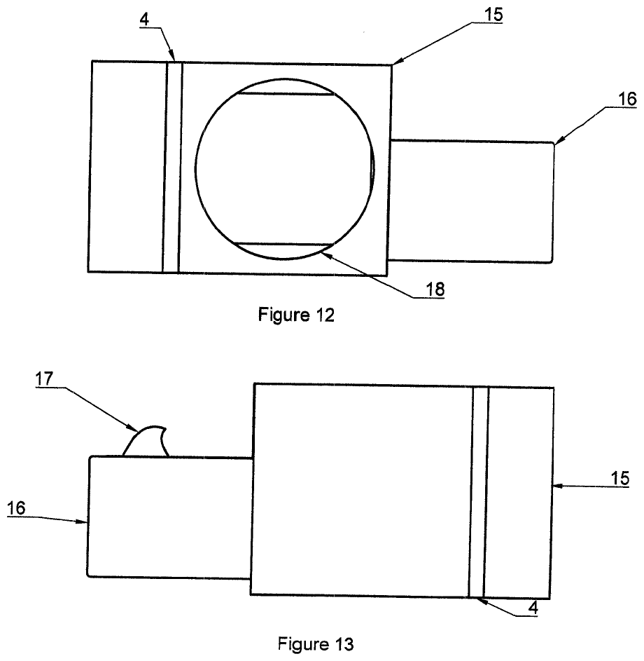

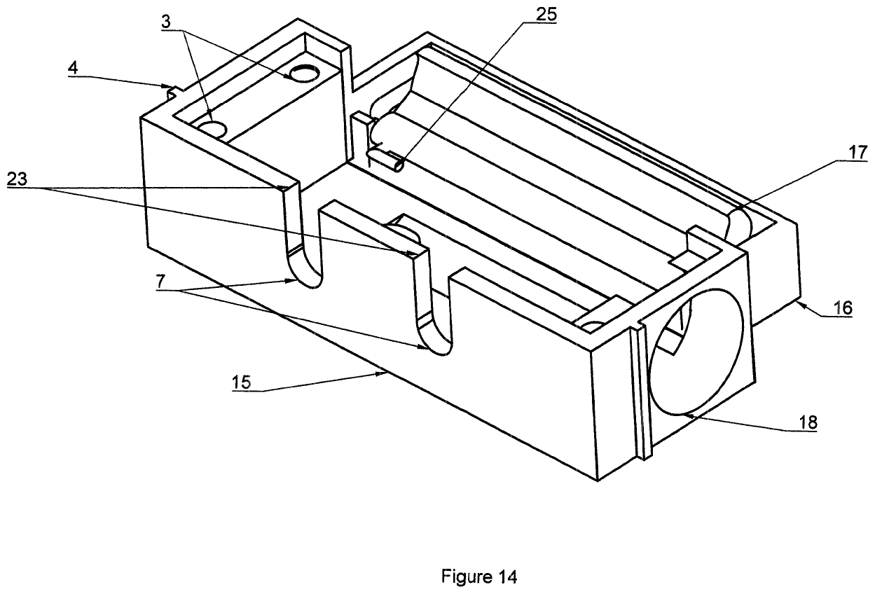

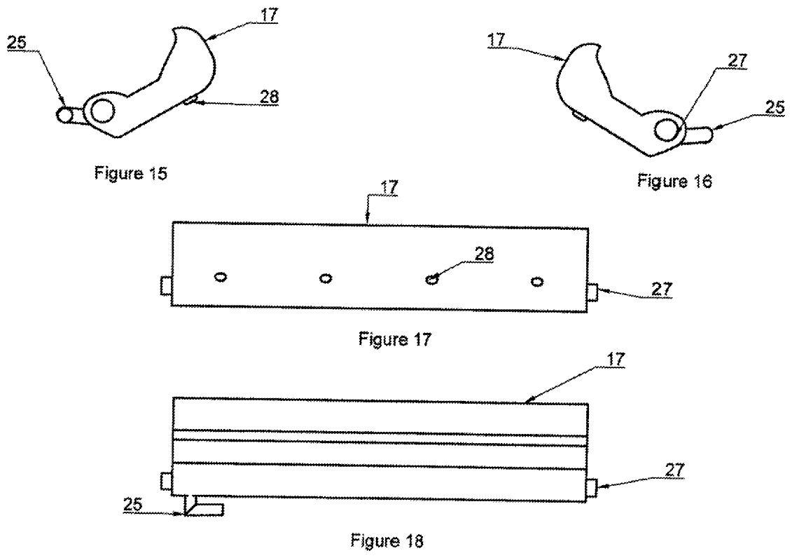

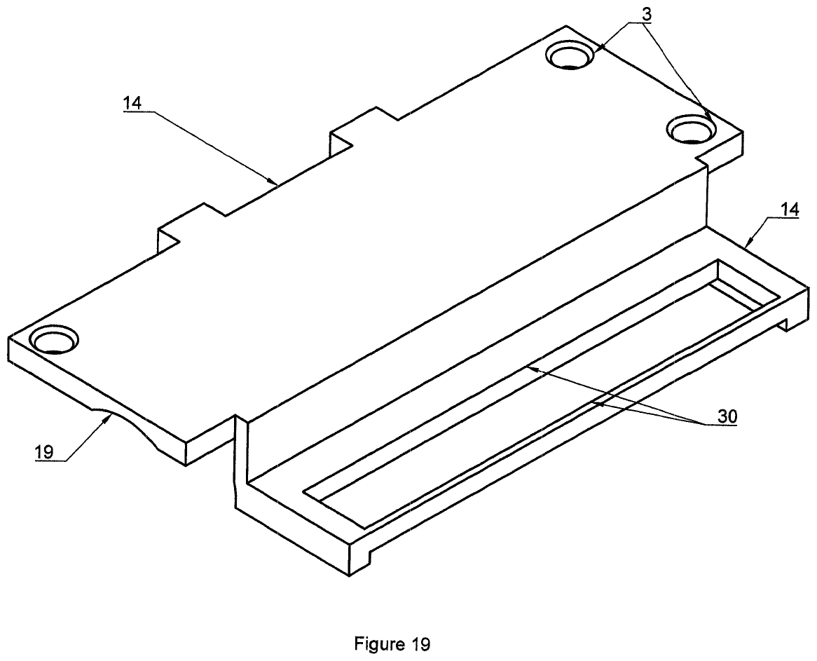

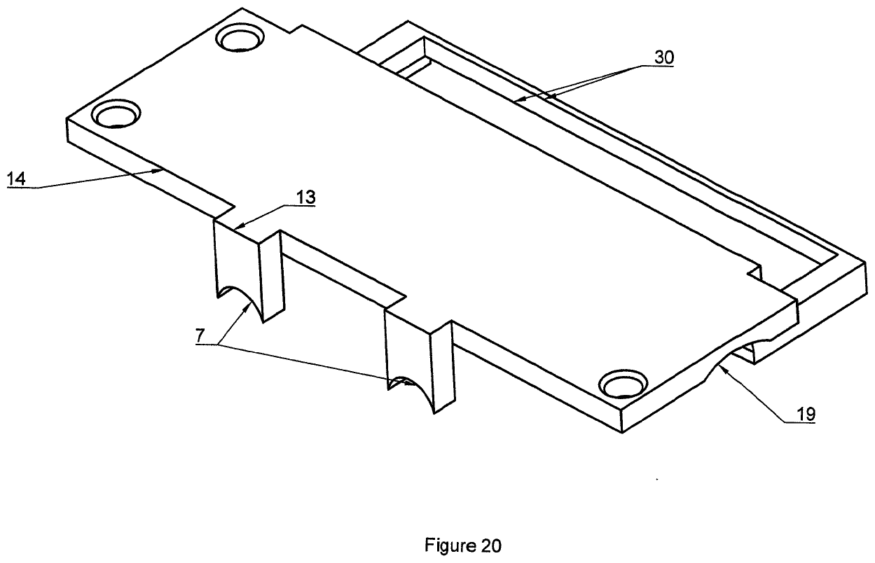

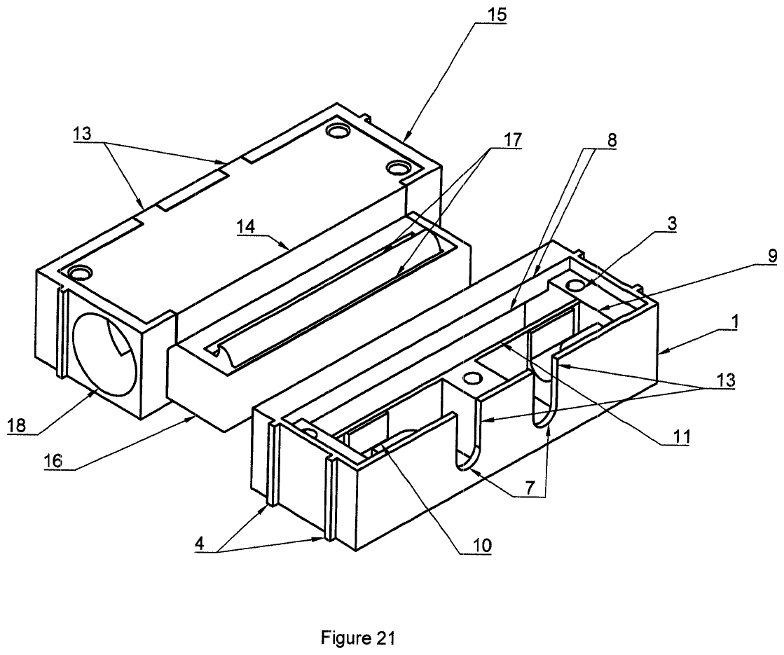

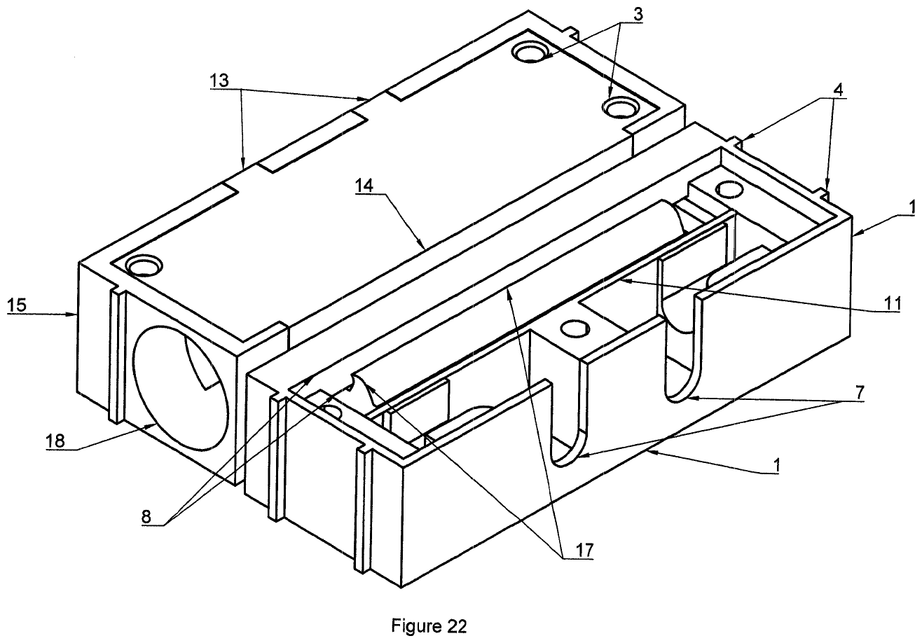

2.) Lock Unit: FIGS. 8 to 20

The Lock Unit 15 is a single metal box with a lid 14, fixed by three screws 3.

The Lock unit has one sidebar 4 situated to both the right and left sides extending from the main box 15 to hold the unit firmly into a watch or similar type strap.

The Lock Unit 15 comprises the Lock Drawer 16, the Lock Bar 17 and the Cylinder Lock holder 18.

The front section of the lock unit 15 has a cut out 24 to accommodate the L shaped lid 14.

The main section contains two holes 7b in the rear of the unit 15 to allow for the Loop end of the cable FIG. 23 31 to be inserted in to the unit 15.

The holes 7b in the rear of the unit 15 have a slot 23a cut above them into the box 15 to facilitate assembly.

There is a cable guide 22 situated between the holes 7b in the rear of the unit 15.

A single arm cylinder lock or other type of single armlock unit is inserted via the hole 18 in the right side of the unit 15.

There are curved sections 19 in both the floor of the main unit 15 and the Lid 14 to allow for different types and styles of cylinder lock to be used.

The lock drawer 16 extends from the front face of the box 15.

The lock drawer 16 has slightly bevelled edges on all four corners and edges to assist in a smooth integration when inserting the lock drawer 16 into the receiver slot 5.

The lock drawer 16 has a section 30 cut out of the lid 14 to facilitate the lock bar 17 movement.

The lock drawer 16 has two blocks 20 on the right and left side to support the lid 14 and to house the rotation holes 21 for the lock bar 17.

The lock bar 17 is a single curved and bevelled shaped unit with a rod 27 at each end.

The lock bar 17 has an L shaped extension bar 25 to connect to the single arm of the cylinder style lock to allow for the lock bar 17 to be lowered below the lid 14 front section to remove the drawer 16 from the slot 5.

The lock bar 17 has four spring holders 28 on the bottom to hold the retaining springs.

The lock bar 17 can also utilise an L shaped Spring.

The lock bar 17 is housed inside the drawer 16.

The lock bar 17 runs the length of the lock drawer 16.

The two rods 27 of the lock bar 17 are seated in the housings 21 which allow the free revolution movement of the lock bar.

The lock bar 17 by way of four springs situated at 28 or two L shaped springs situated at 21 can freely move up and down.

The lock bar 17 is set so that it's natural position is in the up position.

The Lock bar 17 is stopped from leaving or excessively extending from the drawer unit 16 by the position of the slot 30 in the top of the lower section of the lid 14.

The lock bar 17 has a bevelled front leading edge 26 to match with the receiver unit 6 and assists in pushing the lock bar 17 into the Receiver 1.

The lock bar 17 is fully seated once the drawer unit 16 has been fully inserted into the receiver 1 and the locking edge 8 has made contact with the front face of the lock bar 17.

The Lock bar 17 cannot be lowered to separate the receiver unit 1 from the lock unit 15 without a key operated cylinder style lock inserted at 18.

The lid 14 of the lock unit 15 is L shaped to cover the lock unit 15 main section and the drawer section 16 and has a section cut out 30 in the lower section to allow for the front section of the lock bar 17 to raise above the drawer lid height.

The lid 14 of the Unit 15 contains two side bars 23b on the rear edge to enclose the holes 23a for the cable.

The top of the Lid 14 covers the main section and contains three screw holes 3 to secure the lid 14 utilising non removable type screws.

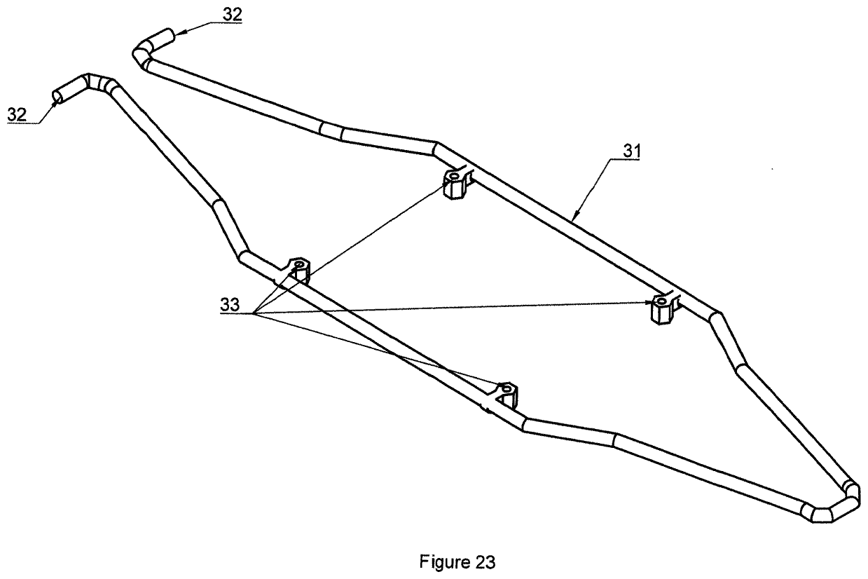

FIG. 21 shows the receiver unit 1 and lock unit 15 in a separated position.

FIG. 22 shows the receiver unit 1 and lock unit 15 in the locked position.

3.) Steel Cable: FIGS. 23 & 24

The cable section 31 runs from the receiver unit 1 to the lock unit 15 and back to the receiver unit 1.

The cable 31 is secured inside the receiver unit 1 by the grommets 32 held in place by the holders 9.

The cable 31 turns at ninety degrees prior to leaving the receiver unit 1 via two holes 7a in the rear of the unit, this is to ensure that a pull of sufficient force cannot remove the cable end from the grommet 32.

The cable 31 enters the lock unit 15 via the holes 7b in the rear of the unit then goes around the cable guide 22 and out through the holes 7b and returns to unit 1.

The cable 31 has 4 brass hexagons 33 connected by couplers to the cable to hold the cable securely within the watch or other type of strap.

The brass hexagons 33 also allow for a watch type unit to be securely locked to the cable and inserted in to a watch or other type of strap.

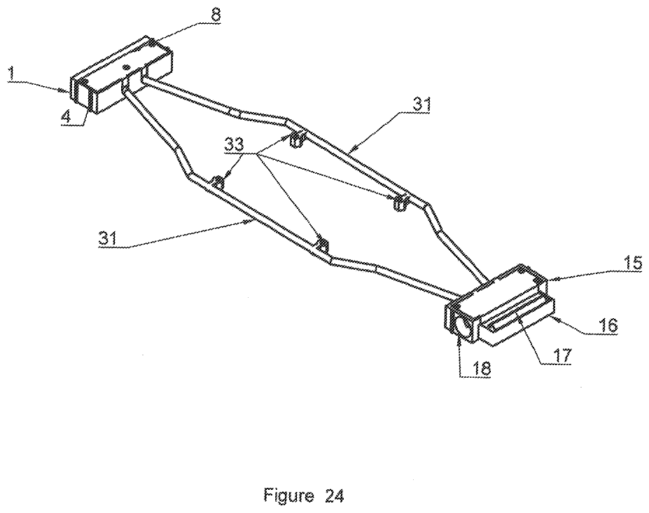

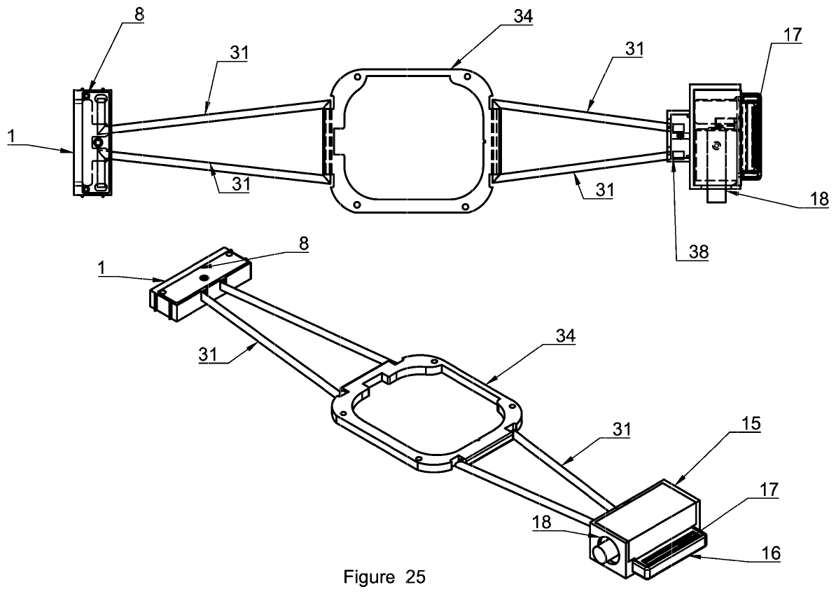

FIG. 24 shows the full unit in it's assembled state.

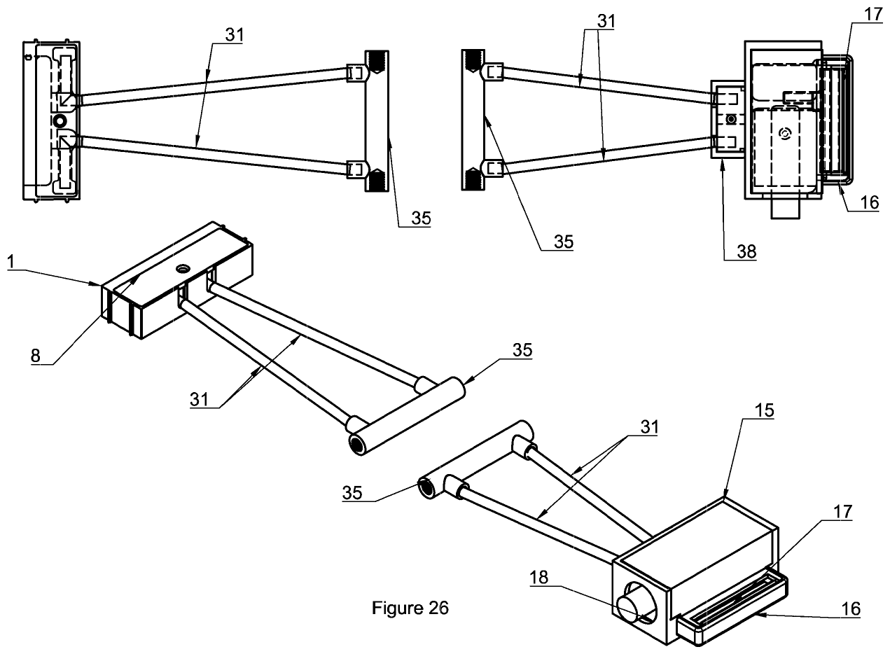

FIG. 25 illustrates another configuration of the steel cable 21 which comprises a steel plate 34. The steel plate 34 is used instead of brass grommets as above to attach the watch or similar to the strap.

The cable section 31 runs from the receiver unit 1 to the steel plate 34 where it is held by a curved clamp in the steel plate and then the cable 31 returns back to the receiver unit 1.

The cable section 31 runs from the lock unit 15 to the steel plate 34 where it is held by a curved clamp in the steel plate and then the cable 31 returns back to the lock unit 15.

FIG. 26 illustrates a further configuration of the steel cable comprising a twin cable pin attachment system. The pin holder 35 holds the two cables 31 by way of a clamp-style pressure holder attached to the pin at two places.

The pin holder 35 has two threaded screw holders at each end to accommodate a screw attachment to the arms of a watch or similar style unit.

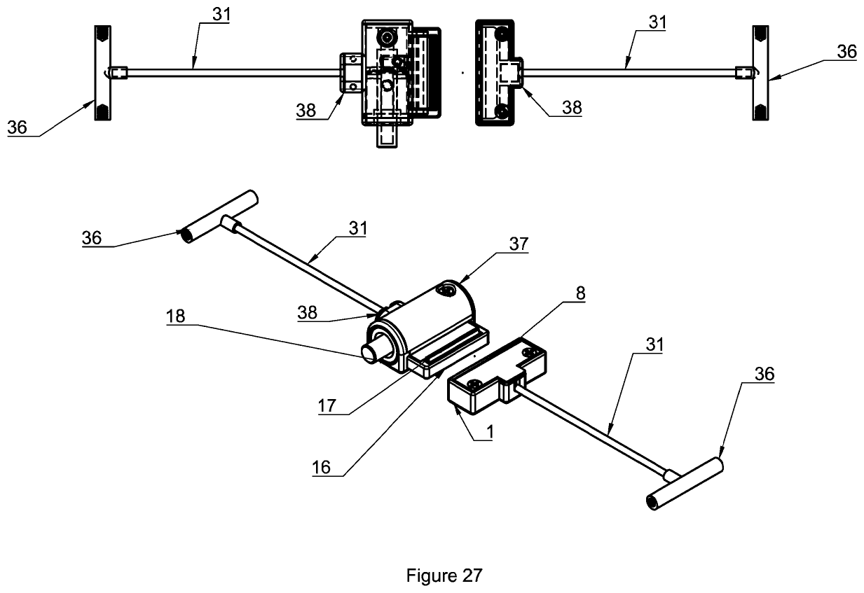

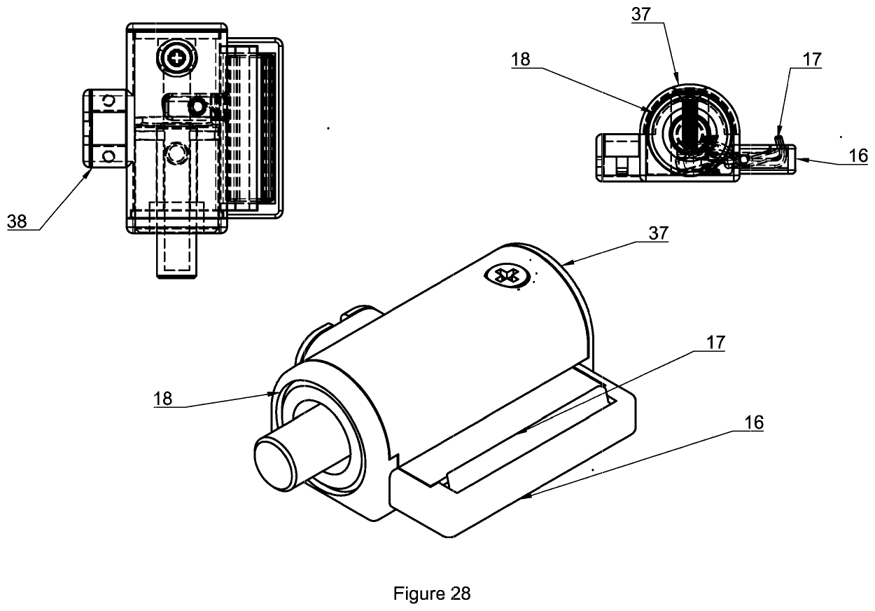

FIG. 27 illustrates a further configuration of the steel cable which comprises only/exactly a single cable in each strap. The Pin Holder 36 is similar to the pin holder 35 but has only a single clamp-style pressure holder to hold the cable 31 at the central point of the pin holder 36. FIG. 28 illustrates another configuration of the lock unit which is curved. A curved style lid 37 is utilised instead of the flat style lid 14 in order to give a lower profile for straps used on a watch or similar device for young children.

A small cable housing is attached to the rear of the units 1 and 15. The cable housing 9 is now situated at the rear of the units 1 and 15 allowing for either a single or dual cable attachment to accommodate the lower profile unit

The following statements provide further disclosure:

1.) A locking device designed to be incorporated into a watch or other type of strap comprising:

a frame structure that defines a cavity for receiving a sliding member through a sliding movement of the sliding member, wherein the frame structure comprises:

an opening in the face of the frame structure and having a bevelled section that is horizontal to the sliding movement, and

a latch that is formed on a surface frame of the frame structure within the cavity; and the sliding member that slides in accordance to to the sliding movement in to the cavity, wherein the the sliding member comprises:

a latching device that corresponds to the latch,

a frame structure with a tongue section on one face of said frame structure.

2.) The Locking device as defined in statement 1, wherein the tongue section locks a latching device along the horizontal edge of the opening when the sliding member is inserted in to the cavity.

3.) The locking device as defined in statement 2, wherein the tongue section that forms the extension on the face is an extended frame structure.

4.) The Locking device as defined in statement 1, wherein both a free edge and a wall at the end of the latch limits backward movement for the sliding member and allows disengagement only by way of the latch arm and a backward pull of the locking device.

5.) The Locking device as defined in statement 4, wherein the free edge of the latch permits the backwards movement of the latching device only when the latch arm is pushed up.

6.) The Locking device as defined in statement 1, wherein the latching recess is locked onto the latch device in the frame when the tongue is fully inserted.

7.) The Locking device as defined in statement 1, wherein a length of the frame structure ranges between 20 millimetres and 30 millimetres.

8.) The Locking device as defined in statement 1, wherein a thickness of the frame structure ranges between 4 millimetres and 6 millimetres.

9.) The Locking device as defined in statement 1, wherein a height of the frame structure ranges between 4 millimetres and 7 millimetres.

10.) The Locking device as defined in statement 1, wherein the depth of the latching device ranges between 0.05 millimetres and 6 millimetres.

11.) The Locking device as defined in statement 1, wherein a length of the frame structure ranges between 20 millimetres and 30 millimetres, a frame structure thickness that ranges between 4 millimetres and 6 millimetres and a slide member that travels between 0.05 millimetres and 6 millimetres.

12.) A locking device designed to be incorporated into a watch or other type of strap comprising:

a frame structure that defines a cavity for receiving a sliding member through a sliding movement of the sliding member; the sliding member that slides in accordance with the sliding movement in to the cavity where in the sliding member comprises:

a tongue section on one face of the sliding member to facilitate sliding member in to the cavity; and

a snap fit structure comprising a protruding element, located on a surface within a cavity in the top of the sliding member, that retains the sliding member at a cut out within the sliding member after the tongue section slides towards the cavity.

13.) The locking device as defined in statement 12, wherein the protruded element is formed by a latch positioned on the frame structure, the latch having a free edge at an end of the latch that limits the backwards movement of the sliding member.

14.) The locking device as defined in statement 13, wherein the free edge permits the backwards movement when an upward pressure is applied to the latch bar.

15.) The locking device as defined in statement 12, wherein the protruded element is fitted in to the cut out when the tongue section is pushed in to the cavity section.

16.) The locking device as defined in statement 14, wherein the the latch in the frame is formed of a strong resilient material.

17.) A locking device designed to be incorporated into a watch or other type of strap comprising:

a separated area to the rear of the frame structure containing the cavity, which incorporates two independent cable holders within the frame structure on the opposing face to the cavity section of the frame structure and,

a wall like structure incorporated within the frame structure to separate the the cavity from the cable holders.

18.) The locking device as defined in statement 17, wherein the the locking device incorporates a strong resilient cable to join the frame structure containing the cavity and the frame structure containing the tongue section to each other through a watch or similar style strap.

19.) The locking device as defined in statement 17, wherein the cable holders comprise:

a cable holder capable of holding a cable and, a cable grommet holder capable of securing a cable grommet in a slot in the rear section of the frame structure.

20.) The locking device as defined in statement 17, wherein the cable holders have a curved edge to direct and or feed the cable and,

is inserted in to the frame structure containing the cavity section via two holes in the opposing face to the cavity section and,

a separation area set between the two independent cable holders to separate the two cable ends.

21.) The locking device as defined in statement 17, wherein the said cable Begins and terminates in the cable holders at the rear of the frame structure and,

the cable proceeds from the frame structure containing the cavity to the frame structure containing the tongue and returns via a cable guide and,

is inserted in to the frame structure containing the tongue section via two holes in the opposing face to the tongue section.

22.) The locking device as defined in statement 18, wherein the cable secures both the frame structure with the cavity and the frame structure with the tongue in to the watch style or other similar style strap unit ensuring the strap unit cannot be removed by force of a cutting type or style of unit.

23.) The locking device as defined in statement 18, wherein the cable contains four hexagonal style units to secure the cable in to the watch or other type of strap and, the hexagonal style units contain a hole to secure a watch or similar style unit to the cable.

24.) A locking device designed to be incorporated into a watch or other type of strap comprising:

a hole cut in to the side of the frame structure containing the tongue section and,

a groove cut in to the floor of the said frame structure to accommodate a cylinder style or similar single arm style lock operated by way of a key or similar device.

25.) The locking device as defined in statement 23, wherein the cylinder style or similar single arm style lock utilises the single arm mechanism to push the latch bar in to the upward position on the turn of the key or other similar device designed and or used for the purpose of turning the cylinder style lock.

26.) The locking device as defined in statement 14, wherein the latch bar is pushed up by way of the single arm style cylinder lock or other similar style locking mechanism.

27.) The locking device as defined in statement 1, wherein the frame structure containing the cavity are formed from a material that is selected from a group of materials consisting of metals and or composite materials or any combination thereof.

28.) The locking device as defined in statement 12, wherein the frame structure containing the cavity are formed from a material that is selected from a group of materials consisting of metals and or composite materials or any combination thereof.

1. A locking device for locking a wrist/leg worn device, the locking device comprising:
a receiver unit having a frame structure that defines a cavity, wherein the frame structure comprises a locking edge; and
a lock unit comprising a lock bar,
wherein the frame structure defines an opening to the cavity configured to receive the lock bar through a sliding movement of the lock bar into the cavity such that once the lock bar is received within the cavity the lock bar engages the locking edge so as to lock the receiver unit and the lock unit together.

2. The locking device of claim 1, wherein the locking edge is generally parallel to a horizontal length of the receiver unit.

3. The locking device of claim 1, wherein the opening of the frame structure comprises a bevelled section configured to abut against the lock bar during insertion of the lock bar into the cavity such that the lock bar is urged into the cavity.

4. The locking device of claim 3, wherein the bevelled section is generally parallel to a horizontal length of the receiver unit.

5. The locking device of claim 1, wherein the lock bar is biased so as to maintain engagement with the locking edge once the lock bar is received within the cavity, and, optionally, the lock bar is biased using one or more springs so as to maintain engagement with the locking edge.

6. The locking device of claim 1, wherein the lock unit is configured to be unlocked from the receiver unit by unengaging the lock bar and the locking edge.

7. The locking device of claim 1, wherein the lock unit is configured to be unlocked from the receiver unit by using a key.

8. The locking device of claim 1, wherein the lock unit comprises a cylinder style lock configured to unlock the lock unit from the receiver unit by unengaging the lock bar and the locking edge, and, optionally, wherein the cylinder style lock is key operable.

9. The locking device of claim 8, wherein the lock unit comprises a lock holder configured to removably receive the cylinder style lock therein.

10. The locking device of claim 1, wherein the lock bar comprises an extension, preferably an L-shaped extension, and, optionally, wherein the extension is configured to be engaged by a lock of the locking unit, preferably a cylinder style lock, so as to unengaged the lock bar and locking edge upon unlocking of the lock.

11. The locking device of claim 1, wherein the receiver unit is generally in a shape of a rectangular cuboid, wherein the lock unit is generally in a shape of a rectangular cuboid, and wherein the opening of the cavity is defined in a side of the rectangular cuboid of the receiver unit.

12. The locking device of claim 1, further comprising at least one strap extending from the receiver unit and/or the lock unit.

13. The locking device of claim 12, wherein the locking device comprises a first strap extending from the receiver unit and a second strap extending from the lock unit.

14. The locking device of claim 12, wherein the locking device comprises a strap extending from the receiver unit to the lock unit such that the strap connects the receiver unit to the lock unit.

15. The locking device of claim 12, wherein each strap comprises at least one or two cables each running generally along a length of the respective strap, preferably, at least one or each of the cables being steel cables.

16. The locking device of claim 15, wherein each cable is fixedly attached to the receiver unit and/or the lock unit.

17. A GPS tracking device comprising the locking device of claim 1, optionally, wherein the GPS tracking device is configured to be worn around the wrist/leg.

18. A watch comprising the locking device of claim 1, wherein the watch comprises a GPS tracking module.
